(19) United States
(12) Patent Application Publication
(10) Pub. No.: US 2001/0001670 A1
(43) Pub. Date: May 24, 2001

(54) BRIQUET FORMING MACHINE AND FEEDER SYSTEM THEREFOR

(76) Inventors: KENNETH A. KRISMANTH, DUBLIN, OH (US); JOSEPH P. MARSALKA, COLUMBUS, OH (US)

Correspondence Address: STANDLEY & GILCREST LLP, 495 METRO PLACE SOUTH, SUITE 210, DUBLIN, OH, 43017, US

(21) Appl. No.: 09/052,516

(22) Filed: Mar. 31, 1998

Related U.S. Application Data
(60) Provisional application No. 60/042,891, filed on Mar. 31, 1997.

(51) Int. Cl. B29C 51/18

(52) U.S. Cl. 425/237; 425/362; 425/363

(57) ABSTRACT

The briquet forming apparatus of the present invention is basically comprised of a pair of opposed and generally cylindrical forming roll assemblies that each have their co-operating exterior surfaces configured in a novel manner. In a preferred embodiment of the invention each forming roll assembly has multiple, axially spaced-apart, annularly continuous grooves, each groove having a generally semi-circular groove cross-section, and also multiple, axially spaced-apart, annularly continues grooves, each groove having a generally semi-circular groove cross-section, and also multiple, axially spaced-apart annular rows of forming teeth, each forming tooth being the cusp of intersecting arcuate surfaces which are essentially concave and semi-circular in directions along the forming roll circumference and essentially convex and semicircular in directions along the forming roll longitudinal axis, that are alternated with the annular grooves throughout the axial extent of each roll assembly. In the completed apparatus, the grooves of each forming roll assembly cooperate with the forming teeth of the opposed forming roll, and preferably, neither of the opposed forming roll assemblies have cylindrical land surfaces intermediate any adjacent annular groove and alternated forming tooth row.

### CROSS-REFERENCES

This application claims priority from U.S. Provisional Patent Application serial No. 60/042,891 filed Mar. 31, 1997.

### FIELD OF THE INVENTION

This invention relates generally to apparatus for making fuel briquets and the like from different compatible and/or combustible material mixtures, and a feeder system therefor. Such mixtures may be comprised of agricultural products, food products, industry by-products, waste by-products, etc. More particularly the invention concerns an improved briquet forming machine having significantly reduced power and energy requirements for any given product throughput.

### BACKGROUND OF THE INVENTION

Known fuel briquet-forming machines are typically comprised of one or more pairs of co-operating and counter-rotating rolls that have complementary cup-shaped cavities which form and define the shapes of the fuel briquets that are to be produced, each roll cavity defining generally one half of an individual briquet shape. As the rolls are rotated together, compactible fuel material fed from a supply hopper positioned generally above the rolls is compressed by the mating cup-shaped cavities into the desired briquet shapes. The shapes are subsequently dropped from between the rolls and into a discharge chute or the like positioned generally beneath such rolls.

Several disadvantages are associated with the typical fuel material briqueting machine. For instance, the opposed cooperating rolls or cylinders must be very nearly perfectly registered with respect to each other in their counter-rotation to produce an acceptable product. Also, the prior art apparatus utilizes a relatively small percentage (i.e., 40% to 50%) of the roll cylindrical surface for cavity space. The remaining land surfaces on the rolls generate excessive frictional forces during fuel material processing thereby requiring increased machine input power to overcome such friction. Further, it is very expensive to form the cup-shape cavities in the co-operating rolls because of the complementary cavity registration or cavity mating requirement.

Another type of briqueting machine technology is utilized for making fuel compacts having cubic or cylindrical shapes formed in part by extrusion. The additional type of machine utilizes offset rotating rolls which rotate relative to an inner cylindrical surface of the machine housing. As the offset rolls are rotated, a pulverized fuel and binder material mixture fed to the housing interior is extruded radially outwardly through multiple dies which are circumferentially positioned about and carried by the machine housing and which each have a square extrusion opening. Cubic briquet shapes subsequently are cut from the square-section extrusions by a scraper blade or the like. As in the case of the counter-rotating roll equipment, extrusion machine power consumption for a given product throughput is very high in comparison to the briqueting apparatus of the present invention.

Another problem encountered with a rotary pelletizer concerns the proper feeding of the raw materials into the pelletizer. Density, flow rates, back pressures, particle sizes and product adhesive characteristics all enter into the manufacture of a useable pellet. Accordingly, it is desirable to provide a feeder apparatus in a rotary pelletizer that controls the aforesaid flow characteristics of the raw material.

Pelletizers also encounter difficulties when operating upon raw materials that are of non-uniform consistency, or which are not provided to the rollers at uniform flow rates. Thus, it is desirable to be able to provide a briquet forming machine that continues to operate effectively even when provided with such uneven consistencies and/or flow rates.

Thus, apparatus construction simplicity and apparatus operation with minimal internal friction and reduced input power requirements in comparison to known briqueting equipment are important objectives of the present invention. Other objectives of this invention will become apparent during a careful consideration of the descriptive materials and drawings which follow.

### SUMMARY OF THE INVENTION

The briquet forming apparatus of the present invention is basically comprised of a pair of opposed and generally cylindrical forming roll assemblies that each have their co-operating exterior surfaces configured in a novel manner. In a preferred embodiment of the invention each forming roll assembly has multiple, axially spaced-apart, annularly continuous grooves, each groove having a generally semi-circular groove cross-section, and also multiple, axially spaced-apart, annularly continues grooves, each groove having a generally semi-circular groove cross-section, and also multiple, axially spaced-apart annular rows of forming teeth, each forming tooth being the cusp of intersecting arcuate surfaces which are essentially concave and semi-circular in directions along the forming roll circumference and essentially convex and semicircular in directions along the forming roll longitudinal axis, that are alternated with the annular grooves throughout the axial extent of each roll assembly. In the completed apparatus, the grooves of each forming roll assembly cooperate with the forming teeth of the opposed forming roll, and preferably, neither of the opposed forming roll assemblies have cylindrical land surfaces intermediate any adjacent annular groove and alternated forming tooth row.

Also, in addition to the opposed forming roll assemblies with the novel, co-operating exterior surface configurations, the apparatus of the present invention includes a material supply hopper, a briquet discharge chute or conveyor component, and conventional forming roll internal reinforcement, bearing support, and drive shaft elements. Drive gears carried by and keyed to the drive shaft elements are geared to the output shaft of an electric motor of proper operating characteristics.

In an alternate embodiment of the invention the exterior surfaces of the opposed forming roll assemblies may be configured so that all of the annularly continues groove elements are provided in one of the roll assemblies and are spaced without intermediate cylindrical land surfaces to co-operate with annular rows of teeth provided only in the other of the apparatus roll assemblies and also without intermediate cylindrical land surfaces.

The present invention also includes a roller alignment system that may be used in a briquet forming machine.

In broadest terms, the roller alignment system is included in a briquet forming machine for pelletizing a raw material, which includes, in combination: a first generally cylindrical forming roll member having a first axle shaft; a second generally cylindrical forming roll member having a second axle shaft, the first and second cylindrical forming roll member engaging one another; drive means for causing rotation of the first and second forming roll members in opposite rotational directions with respect to each other; and the first axle shaft attached to hydraulic actuator devices adapted to urge the first generally cylindrical forming roll member against the second generally cylindrical forming roll member. It is preferred that the first and second axle shafts be mounted on self-aligning bearings.

The roller alignment system of the present invention may be used with any dual roller briquet forming apparatus, such as those described in U.S. Pat. Nos. 309,117 to Willcox, 5,073,323 to McCartney, and 5,199,269 to Andersson, and including the embodiment of such a device described in detail herein.

The present invention also features a feeder device that provides for improved in-feed of raw materials into the briquet forming rollers. This system includes apparatus for rending the raw material more uniform, and for dispensing the material in an advantageous way into a forming position between the rollers. Such a device may be obtained commercially available from Stamet of California.

In broadest terms the feeder device of the present invention, for dispensing raw material into a dual roller briquet forming machine forming an engagement space, comprises: (a) a bulk hopper adapted to dispense said raw material; and (b) a volumetric disc feeder adapted to receive said raw material from said bulk hopper and dispense said raw material onto said roll members. The volumetric disc feeder may have a variable speed drive device, and may additionally have a transition chute having an adjustable nozzle, such as a slotted nozzle. It is preferred that the transition chute be positioned so as to dispense said raw material directly into the engagement space.

The feeder device of the present invention may be used with any dual roller briquet forming apparatus, such as those described in U.S. Pat. Nos. 309,117 to Willcox, 5,073,323 to McCartney, and 5,199,269 to Andersson, and including the embodiment of such a device described in detail herein.

A more detailed description of the invention is developed with respect to the included drawings.

### DESCRIPTION OF THE DRAWINGS:

FIG. 1 is a perspective view of a preferred embodiment of the briquet forming machine of the present invention;

FIG. 2 is a plan view of the apparatus illustrated in FIG. 1;

FIG. 3 is a schematic sectional view taken along line 3-3 of FIG. 2;

FIG. 4 is a perspective view of the configuration of a representative fuel briquet formed by the apparatus of FIG. 1;

FIG. 5 is an elevation and section view of the apparatus opposed forming roll assemblies taken along line 5-5 of FIG. 3;

FIG. 6 is a schematic elevation and section vie taken along line 6-6 of FIG. 5;

FIG. 7 is a perspective view of a fragment of one of the forming roll elements illustrated in FIGS. 2, 5, and 6; and

FIG. 8 is a schematic plan view of a portion of an alternate embodiment of the briquet forming machine of the present invention.

FIG. 9 is an elevational view of a briquet forming machine with a feeder device in accordance with one embodiment of the present invention.

FIG. 10 is a cross-section view of forming roll elements of a briquet forming machine in accordance with one embodiment of the present invention.

FIG. 11 is a cross-section view of forming roll elements of a briquet forming machine as in FIG. 10, showing the roll elements in a slightly different position during operation.

### DETAILED DESCRIPTION

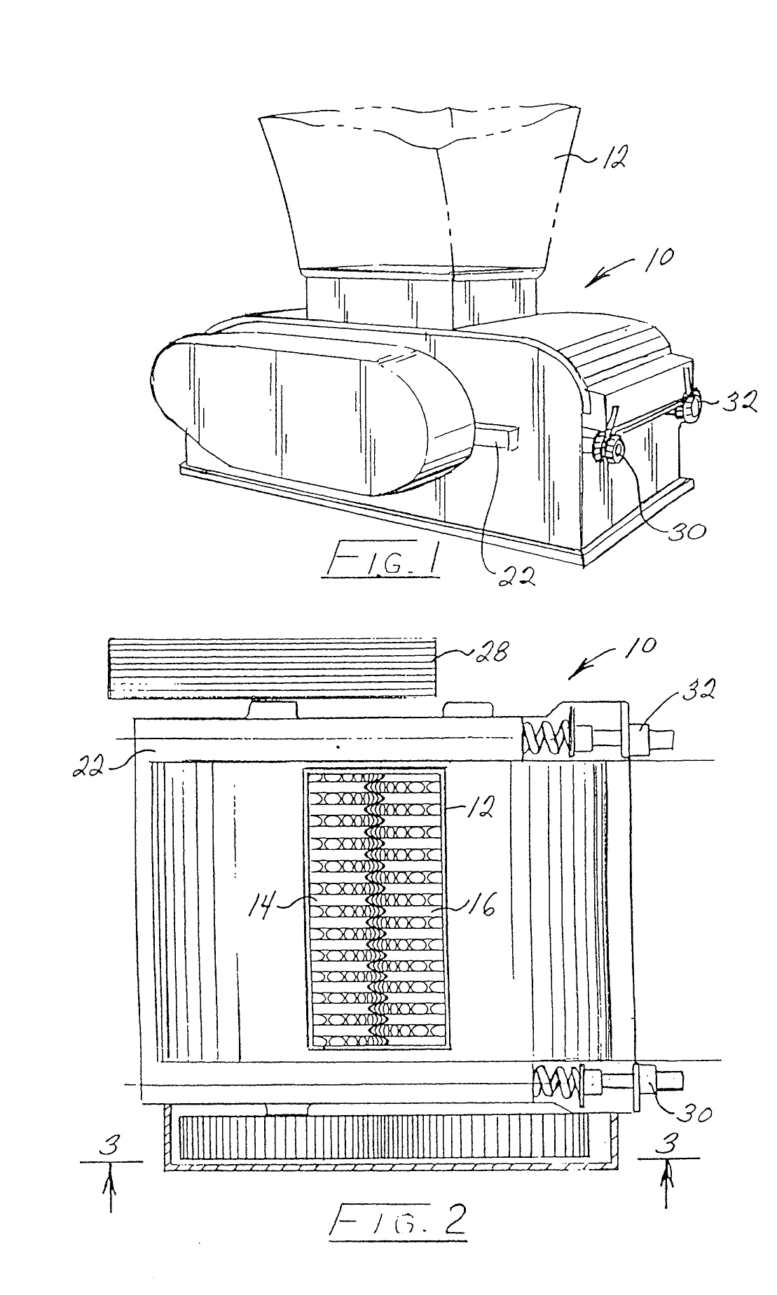

The forming machine of the present invention, designated generally as 10 in the drawings, is particularly useful for forming fuel briquets form a compactible mixture of fuel materials such as coal or carbon particles, sawdust or other wood particles such as wood chips, paper or paperboard particles, and a binder such as paraffin particles. Representative compactible mixture formulations generally include approximately from 10% to 30% by weight of the combustible binder ingredient and approximately from 70% to 90% by weight of the other particulate constituent or constituents. One particularly important application for the briquet forming machine of the present invention involves the compaction of particulate fuels derived from pulverizing or shredding combustible municipal solid waste, such waste generally being comprised of paper, plain and corrugated paperboard, polyethylene, and/or polystyrene materials, and mixed with paraffin binder particles. Of course, machine 10 also may be utilized to from briquettes from other materials such as agricultural products and food products. Such pre-mixed particulate materials are normally feed system hopper as illustrated by phantom lines in FIG. 1. Also, apparatus 10 generally is mounted above a discharge chute unit or discharge conveyor unit (not illustrated in the drawings) and supported by separate structure.

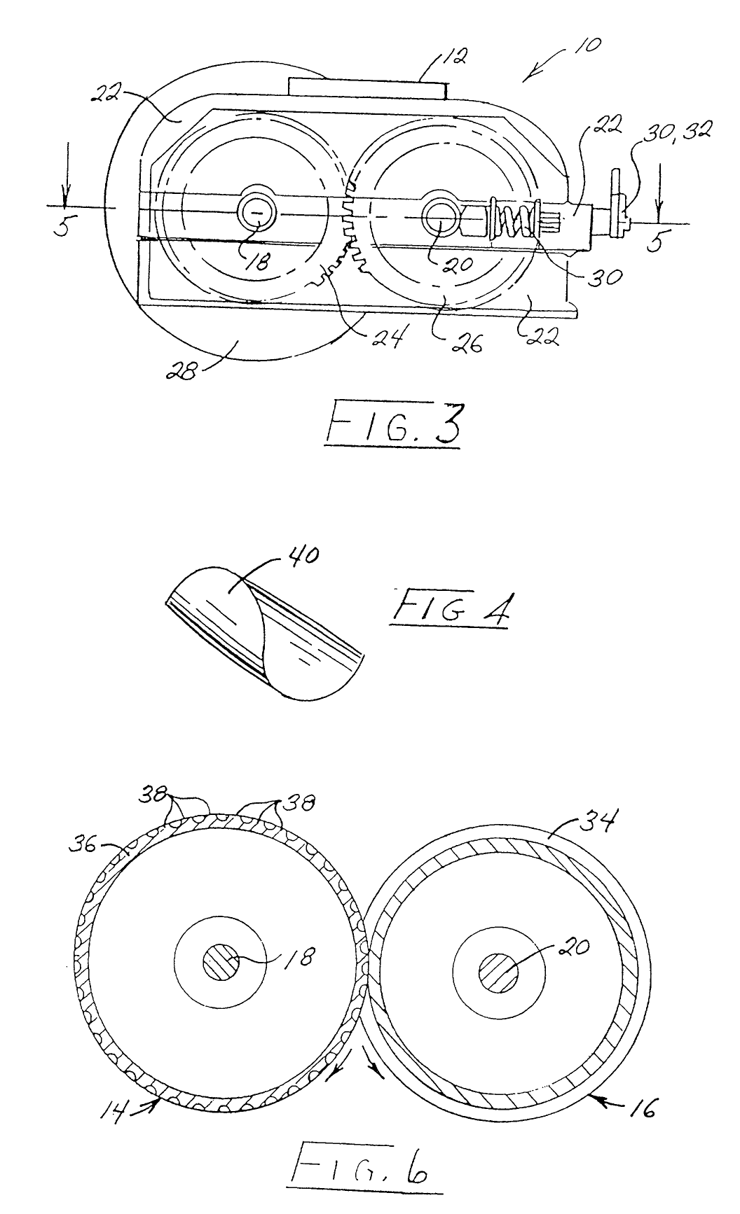

Referring to FIGS. 2 and 3, apparatus 10 is essentially comprised of a pair of opposed, generally cylindrical, forming roll elements 14 an 16 supported by their respective drive shafts 18 and 20 which are in tun carried by structural frame 22. A pair of meshing drive gears 24 and 26 are mounted on and keyed to drive shafts elements 18 and 20, respectively. Also typically included in apparatus 10 is a driven sheave element 28 carried by and co-operating with drive shaft element 18, relief compression spring sub-assemblies 30 and 32 which may be adjusted to permit short-term movement of forming roll 16 away from forming roll element 14 in the event an excessively large particle or object of high harness enters the nip of the co-operating forming roll elements, and electric motor, motor driven pulley, and power transmission belt components (not illustrated) for causing rotation of driven sheave element 28 and its connected apparatus components by the electric motor. Suitable sheet metal housings are provided to enclose the various rotating elements of apparatus 10 as a safety measure.

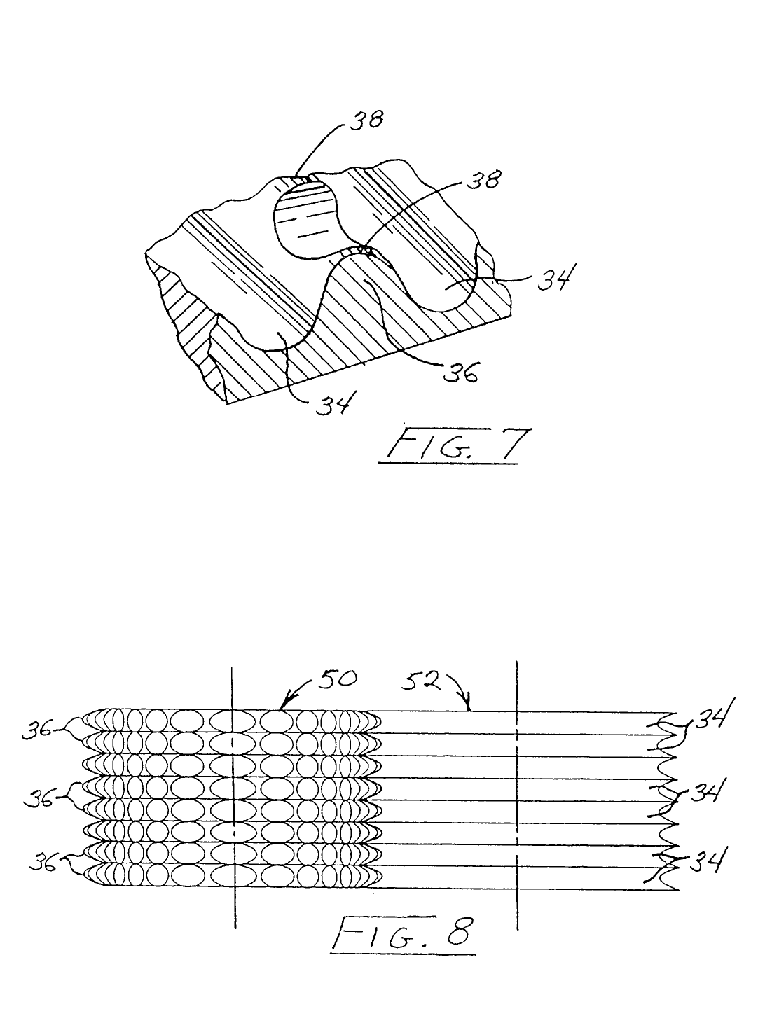

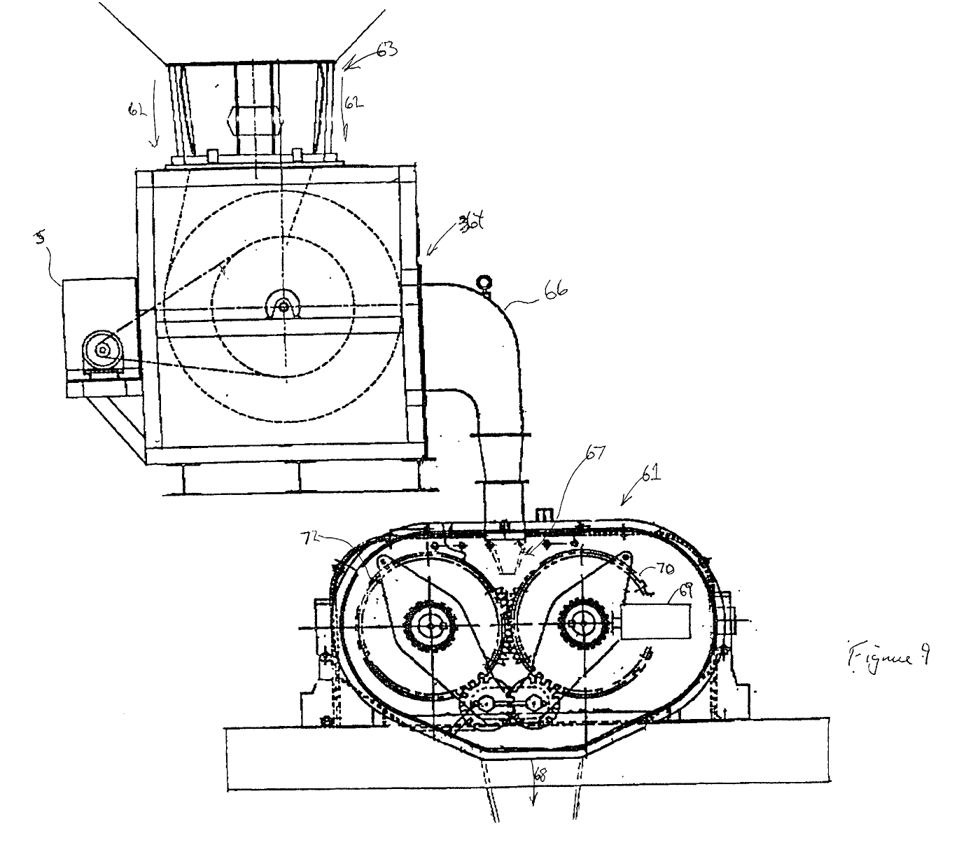

As previously stated, each forming roll element 14, 16 preferably has along its longitudinal axis multiple, spaced-apart, annular forming groove elements 34 and multiple, spaced-apart, annular forming groove elements 34 and multiple, spaced-apart annular rows 36 of forming tooth elements 38, with the forming groove elements 34 being alternated with the annular rows 36 of forming teeth. Also, and at least in part for ease of fabrication, forming grooves 34 each have a substantially semi-circular cross-section throughout their annular extent, and each forming tooth element 38 has a exterior surface configuration that is formed of the intersection of three arcuate, and substantially semi-cylindrical, forming surfaces. The surface configuration of an individual forming tooth element is perhaps best seen in FIG. 7 of the drawings. Also, it is preferred that the hollow cylindrical shapes from which the groove and tooth elements 34 and 38 are machined be fabricated by the forging of an AISI 4140 steel that is subsequently stress relieved after the included stiffener plate elements (illustrated in FIG. 5) may be fabricated of ASTM A-36 steel.

FIG. 5 and 6 of the drawings illustrate the co-operating relationship the preferably exists between the forming groove elements 34 of one of forming rolls 14, 16 and the forming tooth elements 38 of the other such roll, and also the co-operating relationship between he forming tooth elements 38 of the one forming roll and forming groove elements of the other such roll. Also shown in FIG. 5, but not identified by reference numerals, are various reinforcement plates, bushings, keys and keyways typically included in apparatus 10 to properly support and connect forming roll elements 14, 16 to their respective one of drive shaft elements 18, 20.

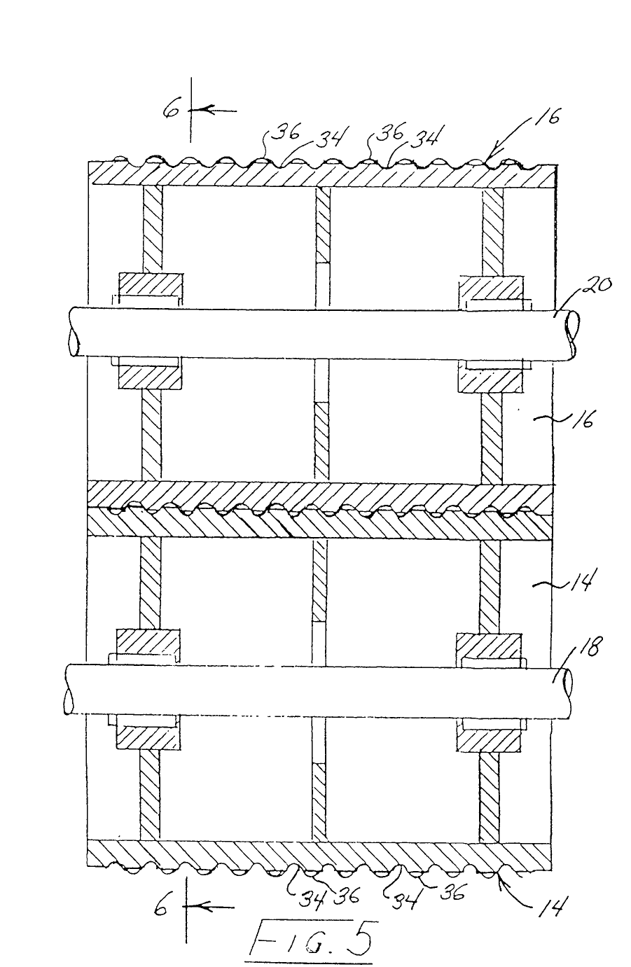

FIG. 4 illustrates the shape of the fuel briquette 40 that is produced by processing the pre-mixed particulate mixture referred to above through apparatus 10. Such apparatus, if having forming rolls approximately 27 inches in diameter and approximately 36 inches in length, is capable of producing approximately 32 tons of briquets per hour utilizing a forming roll rotational speed of approximately 40 revolutions per minute to compact and shape fuel particle mixtures comprised of shredded, combustible, solid materials and 20% to 30% paraffin binder. Under such conditions apparatus 10 requires input electrical energy at approximately a 30 horsepower power level to attain the throughput productions rate. Such performance represents a 300% increase in output with a requirement of 70% less electrical power in comparison to currently available commercial briqueting machines intended for use in a similar application.

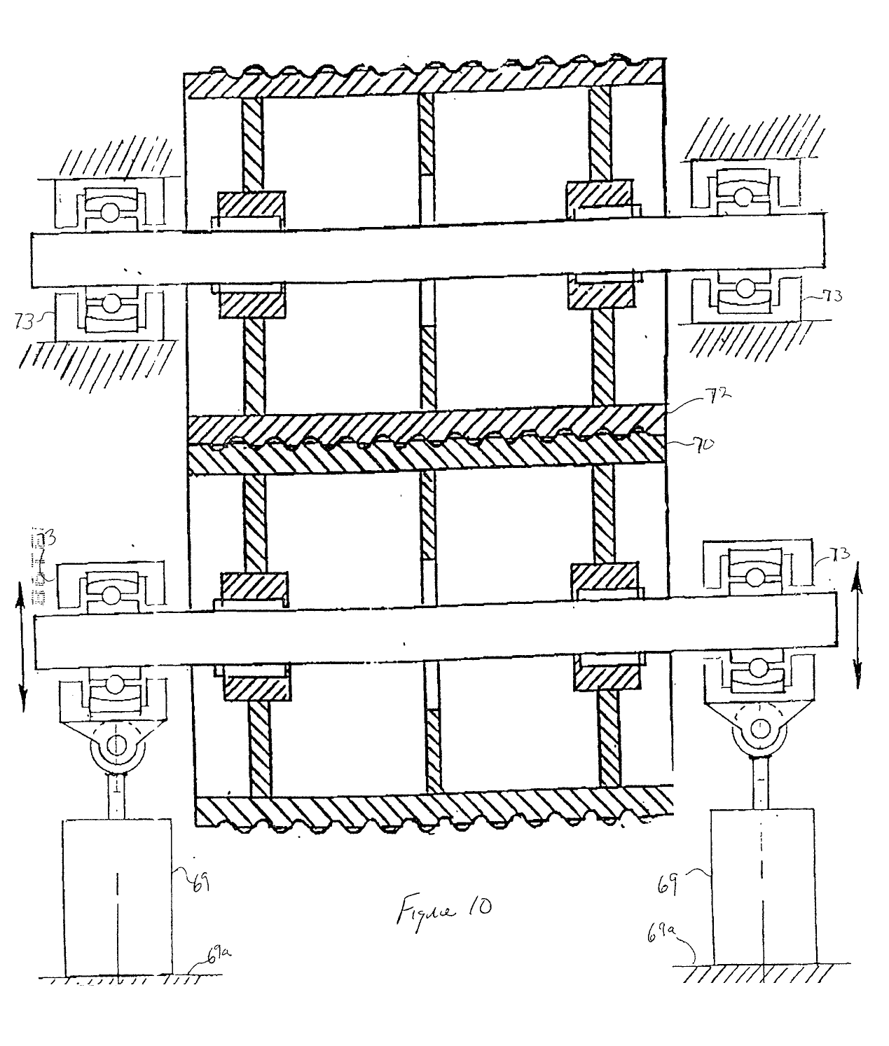

FIG. 8 provides details regarding an alternate arrangement of forming roll elements in a briquet forming machine constructed in accordance with the present invention. Rather than alternating forming grooves with rows of forming teeth in each forming roll the alternate embodiment apparatus has the desired rows of forming teeth 36 all provided on one forming roll element 50, and the meshing annular forming groove elements all provided in the co-operating other forming roll element 52. All other elements of apparatus 10 remain essentially the same.

It has been found that because of the differential surface speeds which exist as between each continuous forming groove element 34 of the one forming roll and the engaged forming teeth 38 of the other forming roll element in apparatus 10, any flash present that might tend to connect one formed briquet with an adjacent formed briquet is pulled apart to thereby cause separated briquets to be discharged from between the forming roll elements and into the normally co-operating product discharge chute.

It should be noted that although the terms “semi-circular” and “semi-cylindrical” are used often in the foregoing description to describe that configuration of the arcuate surfaces that define the forming groove elements 34 and the forming tooth element 38, such invention features and their expressions are not utilized in a limiting or restrictive sense since other generally arcuate surface configurations of greater or lesser cross-sectionals “depth” are satisfactory for use in the practice of this invention. Also, cross-sectionals profiles of the surfaces that define the forming groove elements and forming tooth elements utilized in this briquet forming machine invention may even have included straight-line portions since it is only critical that the forming groove elements have an annular cross-sectional configuration that essentially corresponds to, but is slightly larger than, the cross-sectional configuration of the forming tooth elements that “mesh” with the grooves.

The rotary pelletizer 61 is designed to take a combination of refuse fines, powders, coal, paper waste, sawdust, and the like and form it into useable fuel pellets. These materials may be virgin products or blended materials mixed with exacting ratios with or sometimes without a binder material added to bond the particles together. The rotating pelletizer rolls compress and form these pellets to provide a useful end product.

One of the problems encountered with a rotary pelletizer concerns the proper feeding of the raw materials into the pelletizer. Density, flow rates, back pressures, particle sizes and product adhesive characteristics all enter into the manufacture of a useable pellet.

The present invention allows one to match the pelletizer with an adjustable feed device (See FIG. 9) that will develop proper in-feed to the pelletizer rolls to minimize pelletizer overload or irregular compaction of the pellets.

In the process, unadulterated or blended raw materials are bulk fed along direction 62 into a hopper system and are available for pelletizing. These materials gravity flow through a vibratory in-feed transition device 63, and into the input end of a volumetric disc type feeder device 64. The feeder device is driven by a variable speed drive 65, to provide a constant adjustable rate of flow that precisely matches the material flow needed by the pelletizer rolls. In addition, volumetric disc type feeder device 64 pre-compacts and deaerates the material and pushes it into a transition chute 66, which is designed to direct feed the pelletizer rolls through an diameter-adjustable nozzle system 67. The resulting mechanism provides a ribbon feed of material at the proper nip angle, with the appropriate density, back pressure, and feed rate to satisfy the pelletizer requirements and discharge pellets, issuing along direction 68, in the proper form.

In some instances, the raw materials being processed through the system will be varied in density or resilience and even though the proper volume of product is being fed through the system, there may be slight variances in the density across the width of the pelletizer rolls, which could be in the 36″-60″ range.

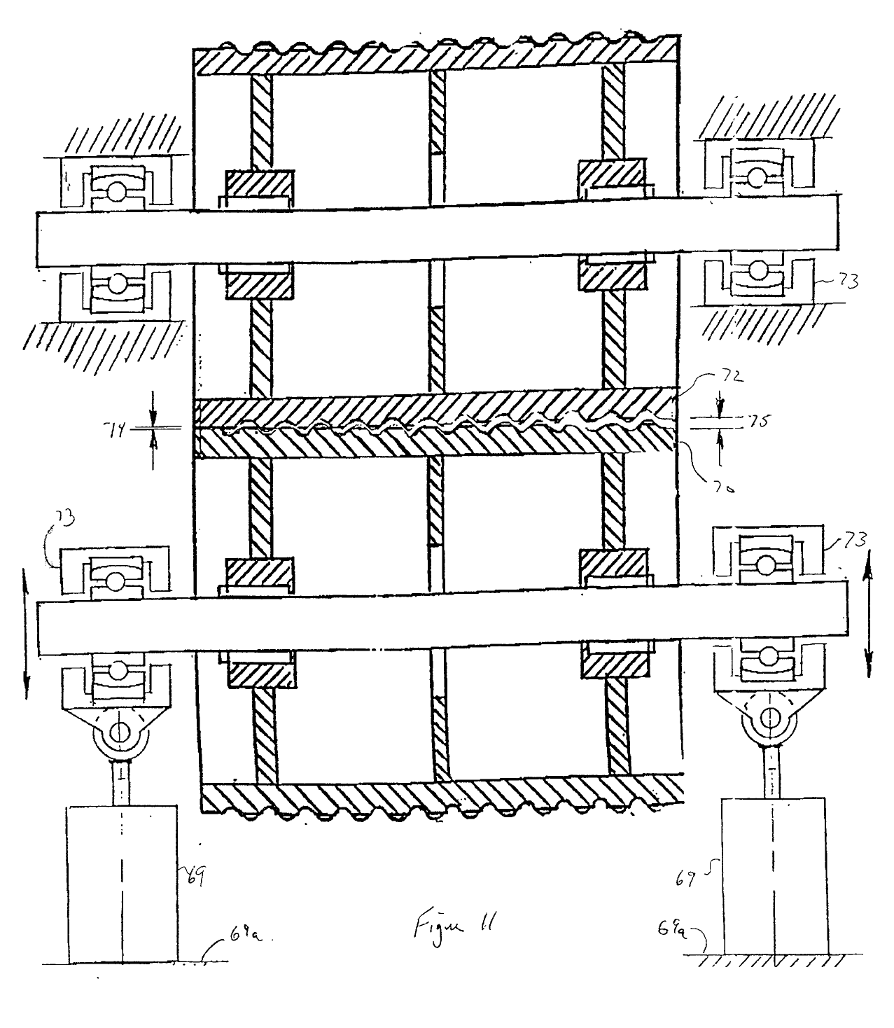

To provide even compaction the pelletizer 61, may be fitted with a system of hydraulic cylinders and self aligning cartridge type bearings as shown in FIGS. 10 and 11. The hydraulic cylinders 69, are fitted to the pelletizer frame 69a on one end and a floating roll 10, on the other end.

In operation, one roll 72 is fixed in overall position with no axial movement. The opposing roll 70 is fitted with self aligning bearing cartridges 73. In normal position, the hydraulic pressure is set for proper compaction and the roll 72, is positioned against adjustable stops.

If, in operation, the material flow is such that one side of the roll receives an excess of high density or large grain size material, the rolls can separate without affecting the compression load of the pellet forming process. In addition, the self alignment of the bearings prevents shaft, bearing or mechanical stresses from overloading parts of the system or losing alignment.

In addition, the cylinders can be set to full retract position to create a full gap between rolls for clearing jams or maintenance purposes.

Since, in normal practice, both rolls are driven in opposing directions and are mechanically identical and interchangeable, they both may be equipped with the self aligning cartridges 73.

FIG. 11 specifically shows how the hydraulic system responds to uneven raw material consistency or flow, by allowing one roll to be displaced slightly while maintaining pressure between the two rollers (compare the distances 74 and 75 in FIG. 11).

Still other component shapes, sizes and materials may be substituted for the component shapes, sizes, and materials described above to obtain the advantages of this invention and without departing from the claimed scope of the invention:

What is claimed is:

1. A feeder device for dispensing raw material into a dual roller briquet forming machine forming an engagement space, said feeder device comprising:
(a) a bulk hopper adapted to dispense said raw material; and
(b) a volumetric disc feeder adapted to receive said raw material from said bulk hopper and dispense said raw material onto said roll members.

2. The feeder device defined by claim I wherein said volumetric disc feeder additionally comprises a variable speed drive device.

3. The feeder device defined by claim 1 wherein said volumetric disc feeder additionally comprises a transition chute having an adjustable nozzle.

4. The feeder device defined by claim 1 wherein said transition chute is positioned so as to dispense said raw material directly into said engagement space.

5. In a briquet forming machine for pelletizing a raw material, in combination:
a first generally cylindrical forming roll member;
a second generally cylindrical forming roll member,
said first and second cylindrical forming roll member engaging one another so as to form an engagement space; and
drive means for causing rotation of said first and second forming roll members in opposite rotational directions with respect to each other; and
a feeder device for said briquet forming machine comprising:
(a) a bulk hopper adapted to dispense said raw material; and
(b) a volumetric disc feeder adapted to receive said raw material from said bulk hopper and dispense said raw material onto said roll members.

6. The briquet forming machine defined by claim 5 wherein said volumetric disc feeder additionally comprises a variable speed drive device.

7. The briquet forming machine defined by claim 5 wherein said volumetric disc feeder additionally comprises a transition chute having an adjustable nozzle.

8. The briquet forming machine defined by claim 5 wherein said transition chute is positioned so as to dispense said raw material directly into said engagement space.

9. In a briquet forming machine for pelletizing a raw material, in combination:
a first generally cylindrical forming roll member having multiple annular forming groove elements spaced-apart along the first forming roll member longitudinal axis and separated from each other by multiple annular rows of spaced-apart forming tooth elements;
a second generally cylindrical forming roll member having multiple annular forming groove elements spaced-apart along the second forming roll member longitudinal axis and separated from each other by multiple annular rows of spaced-apart forming tooth elements,
said first and second cylindrical forming roll member engaging one another so as to form an engagement space; and
drive means for causing rotation of said first and second forming roll members in opposite rotational directions with respect to each other,
each annular forming groove element of said first forming roll member engaging and co-operating with a respective one of the annular rows of forming tooth elements of said second forming roll member, and each annular forming groove element of said second forming roll member engaging and co-operating with a respective one of the annular rows of forming tooth elements of said first forming roll member; and
a feeder device for said briquet forming machine comprising:
(a) a bulk hopper adapted to dispense said raw material; and
(b) a volumetric disc feeder adapted to receive said raw material from said bulk hopper and dispense said raw material onto said roll members.

10. The briquet forming machine defined by claim 9 wherein said volumetric disc feeder additionally comprises a variable speed drive device.

11. The briquet forming machine defined by claim 9 wherein said volumetric disc feeder additionally comprises a transition chute having an adjustable nozzle.

12. The briquet forming machine defined by claim 9 wherein said transition chute is positioned so as to dispense said raw material directly into said engagement space.

13. The briquet forming machine defined by claim 9 wherein said first and second forming roll member annular forming groove elements each have a generally concave arcuate cross-sectional shape, and wherein said first and second forming roll member annular rows of space-apart forming tooth elements each have forming tooth elements that have a generally convex arcuate cross-sectional shape that corresponds to said groove element generally concave arcuate annular cross-sectional shape.

14. The briquet forming machine defined by claim 13 wherein said generally concave and generally convex arcuate cross-sectional shapes are substantially semi-circular cross-sectional shapes.

15. In a briquet forming machine, in combination:
a first generally cylindrical forming roll member having multiple annular forming groove elements positioned adjacent each other along the first forming roll member longitudinal axis;
a second generally cylindrical forming roll member having multiple annular rows of spaced-apart forming tooth elements positioned adjacent each other along the second forming roll member longitudinal axis,
said first and second cylindrical forming roll member engaging one another so as to form an engagement space; and
drive means for causing rotation of said first and second forming roll members in opposite rotational directions with respect to each other,
each annular forming groove element of said first forming roll member engaging and cooperating with a respective one of the annular rows of spaced-apart forming tooth elements of said second forming roll; and
a feeder device for said briquet forming machine comprising:
(a) a bulk hopper adapted to dispense said raw material; and
(b) a volumetric disc feeder adapted to receive said raw material from said bulk hopper and dispense said raw material onto said roll members.

16. The briquet forming machine defined by claim 15 wherein said volumetric disc feeder additionally comprises a variable speed drive device.

17. The briquet forming machine defined by claim 15 wherein said volumetric disc feeder additionally comprises a transition chute having an adjustable nozzle.

18. The briquet forming machine defined by claim 15 wherein said transition chute is positioned so as to dispense said raw material directly into said engagement space.

19. The briquet forming machine of claim 15 wherein said first forming roll member annular forming groove elements each have a generally concave arcuate cross-sectional shape, and wherein said second forming roll member annular rows of spaced-apart forming tooth elements each have forming tooth elements that have a generally convex arcuate cross-sectional shape that corresponds to said groove element generally concave arcuate cross-sectional shape.

20. The briquet forming machine defined by claim 19 wherein said generally concave and generally convex arcuate cross-sectional shapes are substantially semi-circular cross-sectional shapes.

21. In a briquet forming machine for pelletizing a raw material, in combination:
a first generally cylindrical forming roll member having a first axle shaft;
a second generally cylindrical forming roll member having a second axle shaft,
said first and second cylindrical forming roll member engaging one another;
drive means for causing rotation of said first and second forming roll members in opposite rotational directions with respect to each other; and
said first axle shaft attached to hydraulic actuator devices adapted to urge said first generally cylindrical forming roll member against said second generally cylindrical forming roll member.

22. A briquet forming machine according to claim 21 wherein said first axle shaft is mounted on self-aligning bearings.

23. A briquet forming machine according to claim 21 wherein said second axle shaft is mounted on self-aligning bearings.

24. In a briquet forming machine for pelletizing a raw material, in combination:
a first generally cylindrical forming roll member having multiple annular forming groove elements spaced-apart along the first forming roll member longitudinal axis and separated from each other by multiple annular rows of spaced-apart forming tooth elements, and having a first axle shaft;
a second generally cylindrical forming roll member having multiple annular forming groove elements spaced-apart along the second forming roll member longitudinal axis and separated from each other by multiple annular rows of spaced-apart forming tooth elements, and having a first axle shaft;
drive means for causing rotation of said first and second forming roll members in opposite rotational directions with respect to each other,
each annular forming groove element of said first forming roll member engaging and co-operating with a respective one of the annular rows of forming tooth elements of said second forming roll member, and each annular forming groove element of said second forming roll member engaging and co-operating with a respective one of the annular rows of forming tooth elements of said first forming roll member; and
said first axle shaft attached to hydraulic actuator devices adapted to urge said first generally cylindrical forming roll member against said second generally cylindrical forming roll member.

25. A briquet forming machine according to claim 24 wherein said first axle shaft is mounted on self-aligning bearings.

26. A briquet forming machine according to claim 24 wherein said second axle shaft is mounted on self-aligning bearings.

27. The briquet forming machine defined by claim 24 wherein said first and second forming roll member annular forming groove elements each have a generally concave arcuate cross-sectional shape, and wherein said first and second forming roll member annular rows of space-apart forming tooth elements each have forming tooth elements that have a generally convex arcuate cross-sectional shape that corresponds to said groove element generally concave arcuate annular cross-sectional shape.

28. The briquet forming machine defined by claim 27 wherein said generally concave and generally convex arcuate cross-sectional shapes are substantially semi-circular cross-sectional shapes.

29. In a briquet forming machine, in combination:
a first generally cylindrical forming roll member having multiple annular forming groove elements positioned adjacent each other along the first forming roll member longitudinal axis;
a second generally cylindrical forming roll member having multiple annular rows of spaced-apart forming tooth elements positioned adjacent each other along the second forming roll member longitudinal axis;
drive means for causing rotation of said first and second forming roll members in opposite rotational directions with respect to each other,
each annular forming groove element of said first forming roll member engaging and cooperating with a respective one of the annular rows of spaced-apart forming tooth elements of said second forming roll; and
said first axle shaft attached to hydraulic actuator devices adapted to urge said first generally cylindrical forming roll member against said second generally cylindrical forming roll member.

30. A briquet forming machine according to claim 24 wherein said first axle shaft is mounted on self-aligning bearings.

31. A briquet forming machine according to claim 24 wherein said second axle shaft is mounted on self-aligning bearings.

32. The briquet forming machine of claim 29 wherein said first forming roll member annular forming groove elements each have a generally concave arcuate cross-sectional shape, and wherein said second forming roll member annular rows of spaced-apart forming tooth elements each have forming tooth elements that have a generally convex arcuate cross-sectional shape that corresponds to said groove element generally concave arcuate cross-sectional shape.

33. The briquet forming machine defined by claim 32 wherein said generally concave and generally convex arcuate cross-sectional shapes are substantially semi-circular cross-sectional shapes.
